(19) United States
(12) Patent Application Publication
(10) Pub. No.: US 2025/0094911 A1
(43) Pub. Date: Mar. 20, 2025

(54) PHYSICAL DEMANDS CHARACTERIZATION SYSTEM AND METHODS

(71) Applicant: W. L. Gore & Associates, Inc., Newark, DE (US)

(72) Inventors: Hailey Felts, North East, MD (US); Paul Knight, Spokane, WA (US); Dattatreya R. Panse, Lincoln University, PA (US)

(21) Appl. No.: 18/888,666

(22) Filed: Sep. 18, 2024

Related U.S. Application Data
(60) Provisional application No. 63/539,182, filed on Sep. 19, 2023.

(51) Int. Cl. G06Q 10/0639; A41D 1/00; G01P 13/00; G06F 1/16

(52) U.S. Cl. CPC G06Q 10/06398; A41D 1/002; G01P 13/00; G06F 1/163; A41D 2600/20

(57) ABSTRACT

The present disclosure is a system and methods for generating an assessment of the kinematic requirements of a job and its tasks. In more detail, the present disclosure utilizes a plurality of sensor modules as part of a motion shirt. A subject performing a job and its tasks generates data that is captured and sent by a gateway to a server system. The server system processes the data and within novel algorithms and methods outputs a description of multiple tasks and states for a given job.

### CROSS REFERENCE TO RELATED APPLICATION

This application claims the benefit of Provisional Application No. 63/539,182, filed Sep. 19, 2023, which is incorporated herein by reference in its entirety for all purposes.

### STATEMENT REGARDING FEDERALLY SPONSORED R&D

Not related to this application.

### TECHNICAL FIELD

The present disclosure is related to clothing with sensors, and more particularly to a garment system having multiple motion sensors that generate kinematic data for quantifying states of a job and its tasks.

### BACKGROUND

Jobs, whether paid of not, require activity of a worker. Jobs can be a good fit, in that the requirements of the job fit a particular worker and that worker can be productive and create value easily. Conversely, jobs can be a bad fit where the requirements require a worker to perform in a way that creates physical risk, exhaustion, injury and poor performance. Neither a company nor a worker benefit from a job that is a bad fit.

Worker injuries and worker downtime are a significant cost for employers in the US and worldwide. An injury can be caused by many factors including, for example, the speed of a single movement or the repetitions of numerous combined motions. An injury can also be caused by doing a normal activity in a fatigued state. When an injured worker cannot safely complete their job responsibilities and tasks, they often must miss work and focus on recovery. Employers and employees attempt to protect themselves from loss wages and productivity through insurance. Most insurance programs provide only a portion of a worker's wage and fill-in employees are usually not as efficient and productive as existing ones. To protect workers from unsafe and poorly designed jobs, there are laws to ensure certain job standards are met. Employers, workers, and bureaucrats all have a vested interest in understanding the requirements of a job, the requirements are reasonable for the general workforce, and that jobs can be safely done by certain individual employees.

When hiring a new employee, a job posting will typically describe the role, key responsibilities, and the benefits of the job. Some job postings will list high level physical and metal requirements, such as must be able to lift 20 pounds. Potential applicants may have to prove they can perform those high-level tasks. But job postings lack the details of individual tasks of a job, lack a cumulative approach to motions and activities over time and fail to describe all the different physiological and mental states of a task. Example job states not typically listed on a job description may be carrying 5 pounds with one arm, walking backward, raising both hands overhead, twisting a right wrist 30 degrees inward, pinching with a thumb and index finger a small electrical component for 3 seconds every 3 minutes, and bending downward between 15 degrees and 30 degrees 22 times an hour. A job posting is often written by a hiring manager with oversight and contribution from a human resource representative and the job posting is written with best effort focused on high level requirements. Human resource managers and hiring managers lack the experience, data and process to accurately document all the requirements of a job for ensuring it is a good fit for a potential worker.

To increase knowledge of job requirements and to help the process of creating jobs that are a good fit, a physical demands assessment (PDA), physical demands document (PDD) or high-level job task summary is often created. A PDA is an assessment and documentation of the high-level physical demands of a job and is more detailed than a job description. Some companies require PDAs to be created for all jobs. This requirement to have PDAs for all the jobs can be driven by HR policies to reduce compliance risk associated with labor laws such as American with Disabilities Act (ADA). Some companies only do a PDA after a worker is injured or when required by insurance. A PDA is typically created by an employee or a group of employees of a company, but also may be done as a service by outside professionals. PDAs often fall under the responsibility of human resources. PDAs typically describe high-level tasks of a job and document approximately how often those tasks are performed. To get the most value from a PDA, it has to be accurate, objective, current and auditable. There are many gaps and drawbacks to existing PDAs and the process of creating them.

First, filling out a PDA is done by many people with a wide range of experience in ergonomics. Obviously, a person with no experience is unlikely to create a high value and accurate PDA. Studies have shown that even highly experienced ergonomists will have variance between generated studies of the same subject and or job. Consistency and accuracy of PDAs is poor due to subjective input, lack of kinematic data and variance amongst users.

Another challenge with PDAs is that people performing the analysis and filling out forms can have varying motivations. One person may put in the effort to create more accurate PDAs and another person makes the minimal effort and just wants to complete them. Worst case, someone motivated by money may error on the conservative side to provide flexibility to let people have a poor job fit. The data created by PDAs are subjective and can be manipulated.

Another challenge with PDAs is that the inputted data is typically descriptive and not quantified. In the example of how often someone raises their hands above their head, PDA input may be choosing between “never”, “seldom”, “occasionally” and “often”. The PDA data lacks specificity needed to make accurate worker decisions and provides flexibility for varying interpretations. PDAs do not contain accurate values such as a worker raised their hand above their head 15 times per hour, at rate of 1.2 foot per seconds, with wrist angles between 10 degrees and 20 degrees at an average height of 1 foot above their head with a standard distribution of 0.2 feet.

Another challenge with PDAs is that they are often done by an observer that only spends a few minutes watching someone perform tasks and the job. The observer is not able to capture a wide range of time, such as entire shift, or a week of shifts. Users typically observe a few repetitions of a task and document a descriptive value assuming the job function does not vary over time. PDA data accuracy is often poor due to extrapolation.

Another challenge with PDAs is that an observer will typically watch a single person perform a job, or a task, and consider that single observation representative of anyone else doing the same job or task. There is no way for someone to concurrently observe multiple people doing the same job or task at the same time with the same conditions, or at the same time in different locations.

Another challenge with PDAs is that they require an observer to see a worker in the worker's environment and may need multiple views at the same time to see exact states. In many remote or environmentally sensitive jobs, such as surgery or underwater welding, it is too risky to have an ergonomist observer in the same space as someone performing the job. In some of these instances, it would be nearly impossible to have a remote video capture the true body states of the person performing the job and tasks.

Yet another challenge with PDAs is that the observer is not able to process multiple states concurrently. PDAs typically have a limited number of states and easily isolated states such as someone has their hands above their head or is walking. To truly capture important human states during a job or task, multiple states must be observed at the same time, such as wrist angles with hands above the head while walking. With PDAs, the data is not accurate due to the most obvious single state being reported instead of multiple concurrent states.

Yet another limitation of human observed PDAs is that they are limited to what another person can visualize. Complex biological assessments, such as fatigue and stress cannot be determined because the observer has no way to generate the needed real-time data.

Although PDAs and PDDs, and any form of physical demand assessments are a step forward over just job descriptions, their variations and inaccuracies as a result of poor data leave room for improvement. PDAs lack accurate data for creating standardization, describing kinematic states occurring in parallel, quantifiable outcomes, and for creating high value.

### BRIEF DESCRIPTION OF THE DRAWINGS

FIG. 1 is a front perspective view a sensor module used for collecting body data about a subject during a job assessment.

FIG. 2 is the same front perspective view of the sensor module of FIG. 1, but with the top housing removed for showing a battery, printed circuit board, sensor chip and module processor. In subsequent views and for simplicity, the sensor module of FIGS. 1 and 2 are represented by a solid square.

FIG. 3 is a front view of a subject wearing a motion shirt according to the present disclosure. The subject is performing a job assessment and sending data to a gateway.

FIG. 4 is a back perspective view of the motion shirt of FIG. 3 and showing a plurality of sensor modules located in pockets.

FIG. 5 is a perspective view of a hand of a subject wearing the motion shirt of the present disclosure and showing a thumb hole with a right wrist sensor module located in a pocket.

FIG. 6 is a diagram of a motion system according to the present disclosure. FIG. 6 shows a plurality of subjects wearing a motion shirt which reports data to a gateway in communication to a server system for outputting an assessment describing states of a job and its tasks.

FIG. 7 is a flow diagram showing the process of generating data from a plurality of sensors and outputting a job task summary.

FIG. 8 is a flow diagram showing the sub-steps of a data capture step.

FIG. 9 is a rear perspective view of a subject wearing the motion shirt of the present disclosure during an assessment and performing a first task having multiple states.

FIG. 10 is a front perspective view of the subject of FIG. 9 and performing a second task having multiple states.

FIG. 11 is a flow diagram showing the process of capturing data for a job, transforming the data into states for one or more tasks of a job. The process results in an output for describing the requirements of a job.

FIG. 12 describe a window having an amount of data and machine learning features generated from the data.

FIG. 13 is an assessment output and showing different ways of presenting state durations for a plurality of tasks of a job.

FIG. 14 is a flow diagram showing the process of creating or modifying a job to suit the capabilities of a particular worker, or an injured worker.

FIG. 15 is a flow diagram showing how a camera system can create labeled data for creating a trained classifier used within the present disclosure.

FIG. 16 shows an alternative embodiment motion shirt having a wired harness bus and an on-body gateway.

### SUMMARY OF THE INVENTION

The present disclosure is a system and methods for generating an assessment of the physical requirements of a job and its tasks, i.e., a job task summary. In more detail, the present disclosure utilizes a plurality of sensor modules as part of a motion shirt. A subject performing a job and its tasks generates data that is captured and sent by a gateway to a server system. The server system processes the data and using novel algorithms and methods outputs a description of multiple tasks and states for a given job.

The output of the job task summary can be used to better place workers in existing jobs, create new jobs optimized for a workforce, reduce workforce injuries and to better decide how and when an injured worker can return to work.

An object of the present disclosure is to accurately determine states of a job and its tasks. The data generated by the one or more sensors are processed through the novel algorithms of the present disclosure and can determine human states at a speed, in parallel, with high accuracy, and can quantify values in ways other methods cannot.

Another object of the present disclosure is to determine states of a job and its tasks for workers in remote locations and in situations where a camera or human observer is unable to access.

Another object of the present disclosure is to capture states about a job and its tasks that are not possible with a human observer or camera methods. Complex human motion can be captured through the one or more sensors of motion sensors and may be combined with biological sensor data from on body sensors, such as heart rate or heart rate variability, to determine complex states such as stress and fatigue.

Another object of the present disclosure is to accurately determine states of jobs and their tasks by enabling multiple people, with different body types and exact motions, to create data about the same job. Teaching machine learning classifiers via on-body data from multiple people doing the same job or task via the present disclosure enables more general and accurate state determinations and resulting requirements for an entire workforce. The generalization can be applied to new hires and process improvements across multiple people doing the same job.

An object of the present disclosure is to enable people to come back to work after an injury sooner and more safely by creating an optimized job task summary for a particular person by identifying tasks that match their injured limitations and capabilities. A worker at 80 percent utilization is better than one not working at all.

Yet another object of the present disclosure is to create the job task summary that provides a confidence level for classification of states. A value and confidence level are more useful than subjective descriptors and provide a path for continued improvement.

In a first embodiment, the present disclosure relates to a system, the system comprising A) one or more sensor modules; B) a garment, wherein the one or more sensor modules are configured to generate movement data related to the movement of the garment and timestamp data; C) a first processor, wherein the first processor is configured to: i) communicate with the one or more sensor modules; ii) receive the movement data and timestamp data; iii) store in a memory module a session data; and iv) create one or more session messages comprising the session data from each of the one or more sensor modules; and D) a second processor, the second processor configured to: i) receive the one or more session messages from the first processor; ii) compile the one or more session messages in order of the timestamp data; iii) create a plurality of time windows comprised of a pre-determined and sequential amount of session messages; iv) compute a feature of at least one of the plurality of time windows, wherein the feature comprises at least a minimum value, a maximum value or a standard deviation; v) utilize a first pre-trained state classifier for determining a first state for at least one of the time windows; vi) utilize a second pre-trained state classifier for determining a second state for at least one of the time windows; vii) determine a total session time; viii) aggregate each of the time windows by each of the at least two states and compute for each of the at least two states a total state output value wherein the state output value is a function of said total session time; and ix) output a job task summary comprised of at least two of the total state output values.

In a second embodiment, the each of the one or more sensor modules of the first embodiment are independently configured to determine at least one of acceleration data, gyroscopic data, tilt data, location (GPS) data, environmental data, heart rate data, body temperature data, blood pressure data, quaternion, stretch, flex, or a combination thereof.

In a third embodiment, the session data of the first or second embodiment comprises a body location for each of the one or more sensors on the garment.

In a fourth embodiment, the second processor of any of the previous embodiments is further configured to filter session messages.

In a fifth embodiment, the job task summary of any of the previous embodiments quantifies the kinematic requirements of a job.

In a sixth embodiment, the system of any of the previous embodiments comprises two or more garments, each garment comprising one or more sensor modules, and the first processor is configured to store a session identifier that is different for each of two or more subjects.

In a seventh embodiment, the second processor of any of the previous embodiments is configured to compile the one or more session messages in order of the timestamp data and by the session identifier.

In an eight embodiment, the first and second processors of any of the previous embodiments are the same processors.

In a ninth embodiment, the first or second processor of any of the previous embodiments calculate a joint angle of a subject.

In a tenth embodiments, the job task summary of any of the previous embodiments comprises a classification of stress and/or fatigue.

In an alternative embodiment of the first embodiment, the second processor can be configured to utilize at least two of a pre-trained job task classifier for determining at least two states for at least one of the time windows.

These and other features, aspects, and advantages, of the present disclosure become better understood with regard to the following description and accompanying drawings.

### DETAILED DESCRIPTION OF THE PREFERRED EMBODIMENTS

Some of the general components utilized in this disclosure are widely known in the field of the disclosure, and their exact nature or type is not necessary for a person of ordinary skill in the art or science to understand the present disclosure; therefore, they will not be discussed in detail.

It is appreciated that components of networks, network transmission, the internet, databases, and software services are all well known in the art of the internet of things (IoT) and thus their exact features are not needed for one skilled in the art to practice the present disclosure without undue experimentation, and thus will not be described in detail.

As used herein, the term “garment” is intended to indicate an article of clothing. While a shirt form factor is shown as the best mode of a garment, the present disclosure should not be limited to such a garment form factor. As used herein, a garment may be a jacket, pant, shirt, coverall, overall, glove, hat, and such.

As used herein, the term “processor” is intended to mean any electronic device which processes data based upon instructions. As used herein, the term “processor” may include memory modules, and any other common circuits necessary to execute instructions and create a desired output.

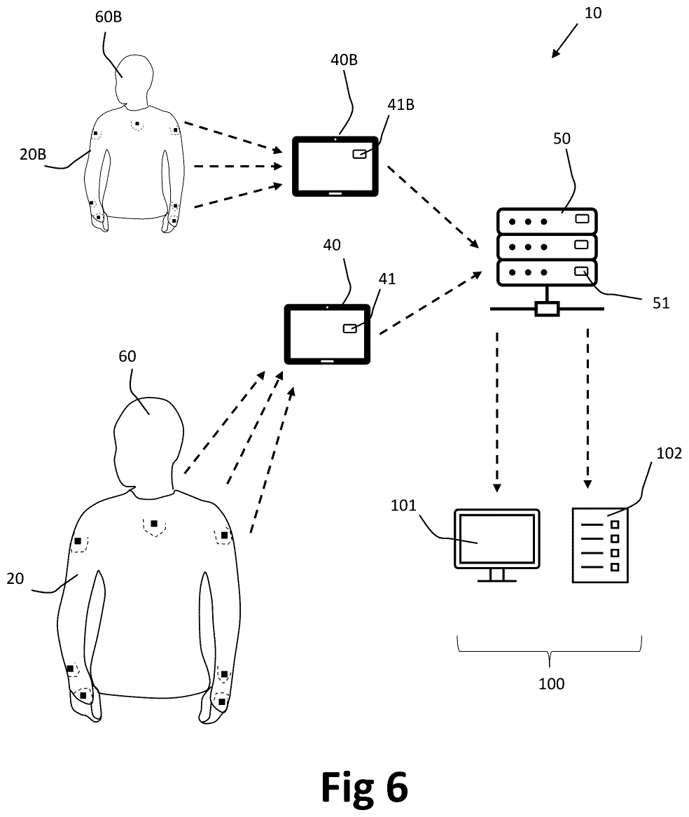

According to the present disclosure, FIG. 6 shows a motion system 10 that is used to characterize one or more tasks of a job. At the highest level and as will be described later in detail, motion system 10 is comprised of a subject 60 generating kinematic movement data and timestamp data by wearing a motion shirt 20 having a plurality of sensors that communicate to a gateway 40. Gateway 40 transmits data and messages to a server system 50 that creates an output 100. Output 100 may provide a kinematic summary of tasks and states of a given job or create an optimized job and tasks for a given worker, also known as a job task summary. Output 100 may be a digital output 101, such as a web application or mobile application view, or a physical output 102, such as printed paper.

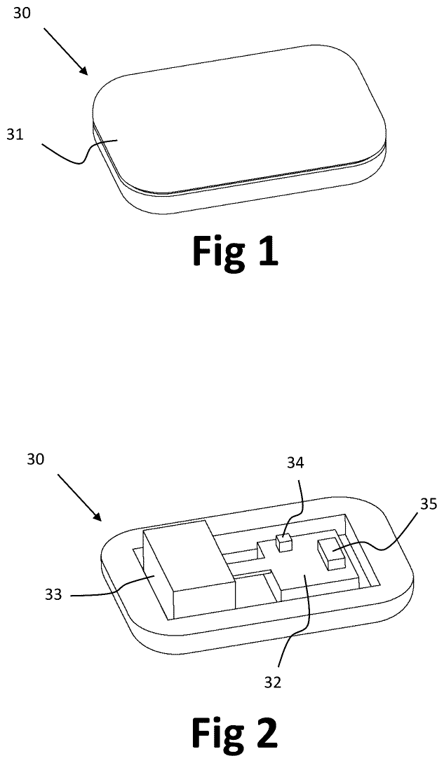

FIG. 1 shows a sensor module 30 having an outer plastic housing 31. Preferably housing 31 is waterproof. FIG. 2 shows sensor module 30 with part of housing 31 removed as to show a battery 33, a printed circuit board 32, a sensor chip 34, and a sensor processor 35. Sensors, electronic components, and hardware are well known in the field of IoT devices and thus the exact components or configuration of module 30 are not needed for one to understand and appreciate the present disclosure. Sensor 34 is preferably an inertial measurement unit (IMU) sensor that generates both movement and timestamp data and is comprised of at least one of an accelerometer 30A, a gyroscope 30B, and a magnetometer 30C. Although any one or combination of sensor 30A, 30B, and 30C can be used within the spirit and scope of the present disclosure to understand body position and motion, the combination of 30A, 30B, and 30C provide the means of determining the absolute orientation of sensor module 30 in world space 3D coordinates. Conversion and data fusion of acceleration, gyroscope and magnetometer data into world space quaternions is well known in the art of motion capture and virtual reality. In addition to motion capture sensors, sensor module 30 may also contain an alternative sensor 30D that may be suitable for describing a given job, a state, or for a particular job location. 30D may be, but is not limited to, a GPS, flex sensor, bend sensor, strain sensor, heart rate sensor, tilt sensor, blood oxygen sensor, body temperature sensor, environmental sensor, or pressure sensor. Alternative sensor 30D may be any sensor that is common in the field of data capture or wearables and sensor chip 34 may be any combination of sensors into one or more packages or chips. Sensor chip 34 provides the means to create movement data that describes variables.

Sensor chip 34 communicates via traces on printed circuit board 32 to module processor 35. As is common in the art of electronics, module processor 35 contains firmware code that allows it to coordinate the components of sensor 30. Module processor 35 may perform functions, such as but not limited to, controlling the charging of battery 33, aggregating and store data from sensor chip 34, and sending and receiving information to gateway 40. Module processor 35 includes a memory module, which can be any type of common memory type, including but not limited to RAM, EPROM or flash memory types.

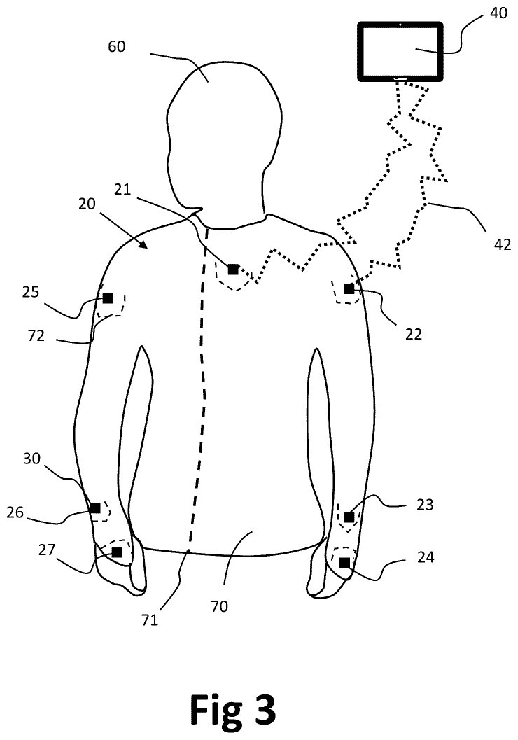

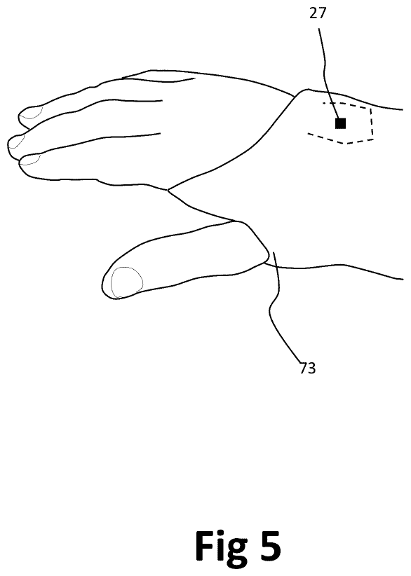

As shown in FIG. 3, a plurality of sensor module 30 are placed on a garment 70 to create motion shirt 20. Garment 70 can be any type of common garment style, fabric or size, but for workforce applications it is preferably lightweight, long sleeved and snug to the body. According to the best mode of the present disclosure and for improved data accuracy, a zipper 71 is located slightly offset to the midplane of garment 70 as to not interfere with any optimal placements of sensor module 30 along the midplane. In addition to occupying midplane space, midline zippers are more likely to cause bunching of fabric. Also, according to the best mode of the present disclosure and shown in FIG. 5 is that garment 70 has extended length sleeves which covers at least a portion of the wrist of subject 60. A thumb hole 73 enables the thumb of subject 70 to protrude through garment 70 and keep its sleeve and either sensor module 24 or 27 in an optimal position for data capture, but without overly restricting subject 70 from performing fine movements with his or her fingers. Thumb hole 73 provides the means of placing a motion sensor distal the wrist joint of subject 60 and to gather hand motion data.

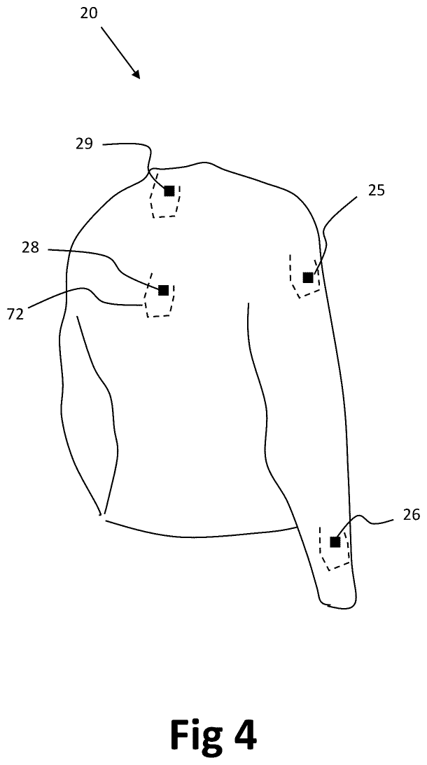

In some embodiments, garment 70 further includes a plurality of pockets 72. Pocket 72 captures and holds sensor module 30 in proximity to a desired body location for capturing data about the job or task being performed by subject 60. Although pockets are well known in the art of clothing, optimal pocket construction and use is described by co-owned and pending U.S. application Ser. No. 17/940,507. U.S. patent application Ser. No. 17/940,507 is hereby incorporated by this reference. As best shown in FIGS. 3, 4 and 5, garment 70 is comprised of seven of pockets 72 for holding a corresponding number of sensor modules 30. A chest module 21 is located along the general midline of subject 60. A left shoulder module 22 and a right shoulder module 25 are located along the right and left humerus bones. A left arm module 23 and a right arm module 26 are located along the radius or ulna bone of the lower arm. A left wrist module 24 and a right wrist module 27 are located distal the radius or ulna bones. Modules 21-27 have been shown by the present disclosure to capture states of subject 60 for many common jobs and tasks. For some body types, jobs and tasks, the value of the resulting data can be improved by including any number of additional sensors including a back module 28 and a neck module 29, or moving existing modules. In other embodiments, motion shirt 20 may include 7 pockets for accommodating 7 sensor modules. In other embodiments, the motion shirt 20 may include 8 pockets, 9 pockets, 10 pockets or more pockets for accommodating a corresponding number of sensors, respectively. While there is essentially no upper limit for the number of pockets, a garment that covers the entire body, for example, a coverall (not shown) would typically capture enough information via no more than 20 pockets and 20 sensors to provide an accurate job task summary.

In some embodiments, motion shirt 20 is comprised of garment 70 and sensor modules 21-29. As shown in FIG. 3, each of sensor modules 21-29 communicate via a wireless channel 42 to gateway 40. Gateway 40 captures the movement and timestamp data from sensors 21-29 and via a gateway processor 41, also known as a first processor, adds to the data and exports the data to server 50. Gateway 40 may be, but is not limited to, a mobile phone, embedded system, tablet, desktop, router or any other type of computer. Gateway 40 communicates with the one or more sensor modules and to server 50 via common technologies such as but not limited to Wi-Fi, cellular or internet-based protocols. Gateway processor 41 may be any type electronics system capable of storing instructions, processing data, storing a session data, creating one or more session messages comprising the session data from each of the one or more sensor modules, and communicating to other electronic systems. Gateway 40 provides the means of aggregating sensor data, adding data through its own input, and communicating to server system 50.

Receiving data, for example, one or more session messages, from gateway processor 41 is server system 50. Server system includes a server processor 51, also known as a second processor, which like module processor 35 and gateway processor 41, may be any type of industry common electronics system and components capable of processing and storing data and may include a memory module and communication chips. Server system 50 provides the means of manipulating data into desired outputs.

Desired output 100, according to the present disclosure, is a job task summary which provides an overview of human states and kinematic requirements for a job. In further detail, the present disclosure provides states for the one or more tasks of a job. A job 220 may be any type of job for a person in the workplace, such as but not limited to a mail delivery person, a worker in a factory, a lone construction worker, an underwater welder or a medical professional. Job 220 is comprised of one or more of a task 222. As used herein, task 222 is a common function or activity by a worker, or workers, and may include, but is not limited to, driving, loading a truck, sorting mail, operating a forklift, painting with a roller, welding, or putting in stiches during surgery. Each task 222 is comprised of one or more of a state 230. State 230 describes the kinematic, biological and/or emotional state of a worker while performing task 222 as part of performing job 220. State 230 may be, but is not limited to, hands above head, walking, running, bending over, heart rate over 90, shoulder abduction greater than 90 degrees, shoulder abduction less than 90 degrees, pinching, grasping with one hand, and lifting with both arms. It should be appreciated that there is no limitation to the type and number of states for a given task or job, and that there can be commonality of states across different tasks and jobs. The components, systems and methods of the present disclosure gather data of subject 60 while performing a known job 220 so that one or more state 230 associated to one or more task 222 is measured, identified, aggregated and stored. The resulting stored data about one or more task 222 and one or more state 230 can inform if a person is suitable to perform job 220, the risks of a person performing job 220, if an injured person can do a portion of job 220, or if job 220 can be created or optimized for a given person.

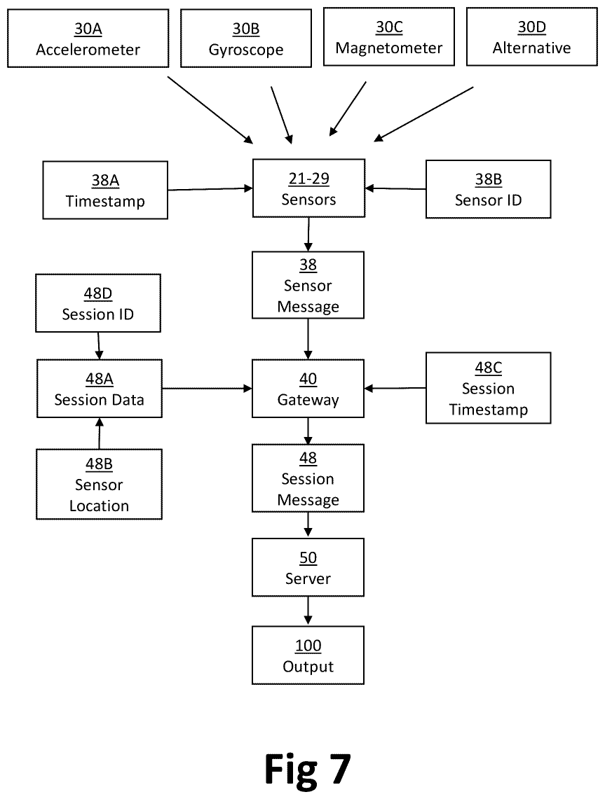

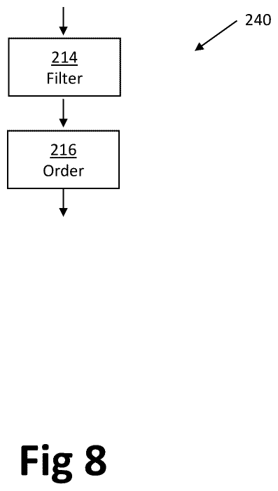

FIG. 7 provides the high-level flow of data for system 10. Sensors 21-29, which are body location specific, may include accelerometer 30A, gyroscope 30B, magnetometer 30C and other sensor 30D. Movement data from sensors 30A-30D is aggregated by sensor 21-29 and sensors 21-29 add a timestamp 38A and a sensor ID 38B to form a sensor message 38. Timestamp 38A may be a date and time or a based upon clock cycles of module processor 35. Sensor ID 38B is a unique identifier stored within module processor 35 for associating a given sensor message 38 to a particular sensor 21-29.

Sensor message 38 may be stored within sensor module 30 and batch sent to gateway 40 or sensor message 38 may be sent in real-time. Gateway 40 receives sensor message 38 and as shown in FIG. 7 adds a session data 48A and optionally a session timestamp 48C. Session data 48A is comprised of a session ID 48D and a sensor location 48B. Session ID 48D may be a unique identifier to identify a particular session message 48 by server 50. Sensor location 48B are a plurality of data pairs for associating a sensor message 38 to a sensor 21-29 of a particular body location of subject 60. During startup, subject 60, or someone else provides input to gateway 40 of where they are placing a particular sensor module 30 to create sensors 21-29. This startup process enables sensor location 48B. Session timestamp 48C utilizes the local time zone of gateway 40 in a date and time format. Because sensor module 30 is unlikely to have a real time operating clock but rather utilizes an incremental processor-based time, session timestamp 48C provides the ability for gateway 40 to compile a plurality of sensor message 38 in order of a subject's local time, and for server 50 to compile a plurality of session messages 48 in order of time as desired. Session timestamp 48C also provides the ability for server 50 to compute the total session time for calculations in creating output 100. The net result is that server 50 holds a large number of session message 48 containing data from sensors and the ability to filter and sort by at least time, session, body location and subject.

To use system 10, subject 60 puts on motion shirt 20. Each of sensor module 30 is placed into the one or more pocket 72 to become one of sensors 21-29. As each of sensor 21-29 is activated, subject 60 or someone else, identifies the body location of each sensor module using gateway 40. Session data 48A is also inputted through gateway 40, such as job name or number. A session is activated, paused, and completed using gateway 40. Subject 60 then performs the tasks of a job. Optionally, a second subject 60B utilizing a second motion shirt 20B communicating to a second gateway 40B having a second gateway processor 41B may also communicate to server system 50. Second subject 60B may perform the same job and tasks as subject 60, as to provide increased data accuracy, or may perform a different job and tasks in parallel to subject 60.

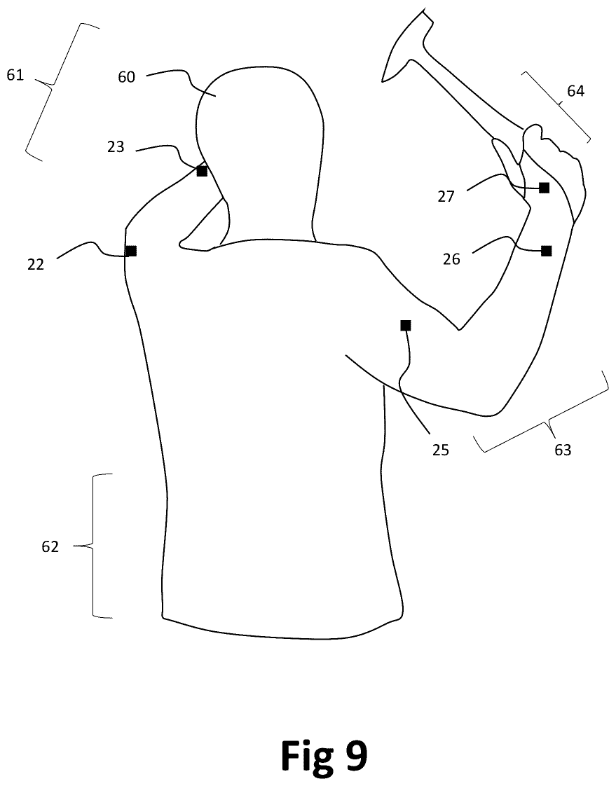

As shown in FIG. 9, subject 60 wearing motion shirt 20 may perform a first hammering task 222 of job 220. Subject 60 is shown having a plurality of states. A first state 61 may be the orientation of the left arm of subject 60. A second state 62 may be if subject 60 is standing, sitting or bending over. A third state 63 may be the activity of hammering with a right arm. A fourth state 64 may be the angular velocity of subject 60's right wrist. Sensors 21-29 provide the means of generating data describing the body of subject 60 for the use of determine a plurality of states. By leveraging the combined sensors 30A-C, a quaternion vector of a bone can be calculated. With two quaternions, a more complex joint angle state may be calculated from the data of two or more of sensors 21-29.

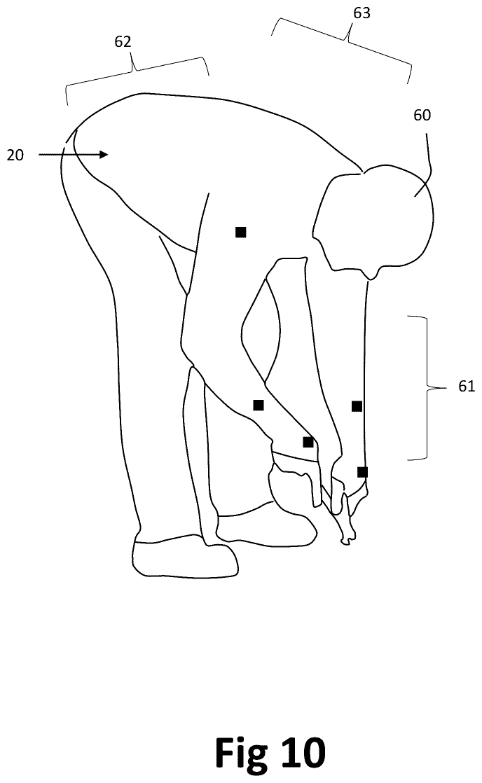

As shown in FIG. 10, subject 60 is performing a second task 222B. In this case, first state 61, second state 62 and third state 63 will generate unique data describing their respective states of bending over, using a handheld tool, for example, pliers and having the left arm of subject 60 pointing down with a 178 degree elbow joint angle. The generated data can be used to train a machine learning classifier 298 of the present disclosure, or the generated data can be put through a trained machine learning classifier 298 to identify states.

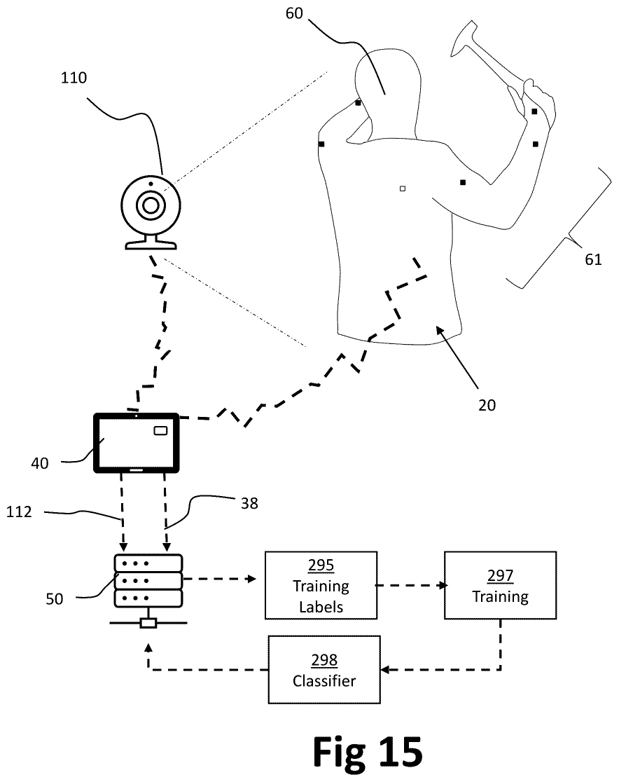

In the event generated data is to be used to train classifier 298 and as shown in FIG. 15, a camera 110 may be optimally placed to take images 112 of subject 60 performing task 222 and send images 112 through gateway 40 to server system 50. Through a trained video classifier, system 50 can process images 112 to generate a plurality of state training labels 295. Human interpretation and approximation may also generate labels 295. Through a training step 297, classifier 298 may learn from training labels 295 which is common in the art of supervised machine learning. Training step 297 utilizes both training labels 295 and processed data as will be described in following paragraphs. It has been found that decision tree learning algorithms provide acceptable results for determining common states for common tasks of common jobs.

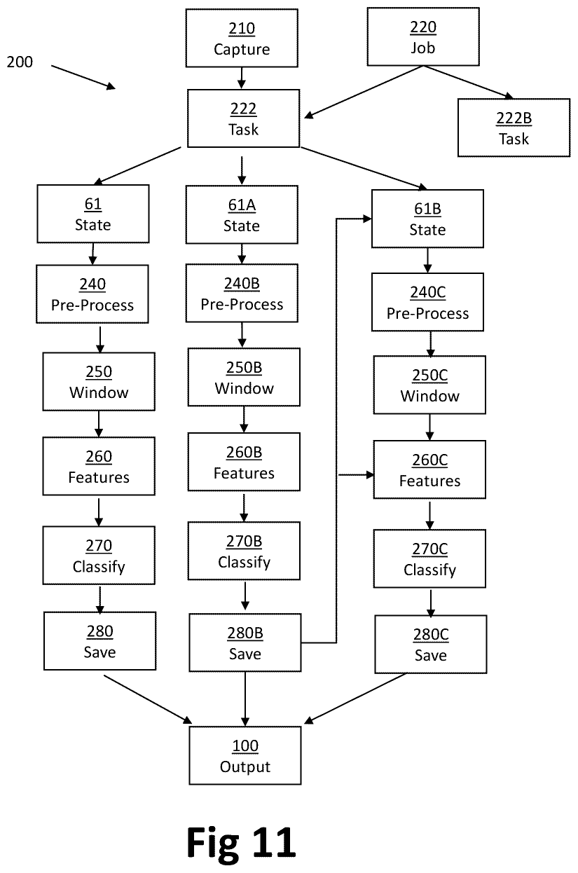

FIG. 11 shows an example of a demand assessment process 200 using generated data to create output 100 that describes the kinematic state requirements of job 220 and its tasks. A first capture step 210 is performed as previously described for having subject 60 wear motion shirt 20 and for inputting data into gateway 40. Job 220 is known to have task 222 and task 222B. In the case of task 222 and through the training process, it is known that task 222 has state 61, a state 61A and a state 61B. In the case of determining state 60, server system 50 performs a pre-process step 240 to perform a filter step 214 and an ordering step 216. Filter step 214 ensures that all data is for subject 60 for a given session and eliminates any missing or bad values, such as ones with noise. For a given state, optimized filtering methods may be used, including but not limited to averaging, median filtering and outlier detection. Ordering step 216 ensures timestamps are adjusted as needed and data is sequential in time for preparation of a window step 250.

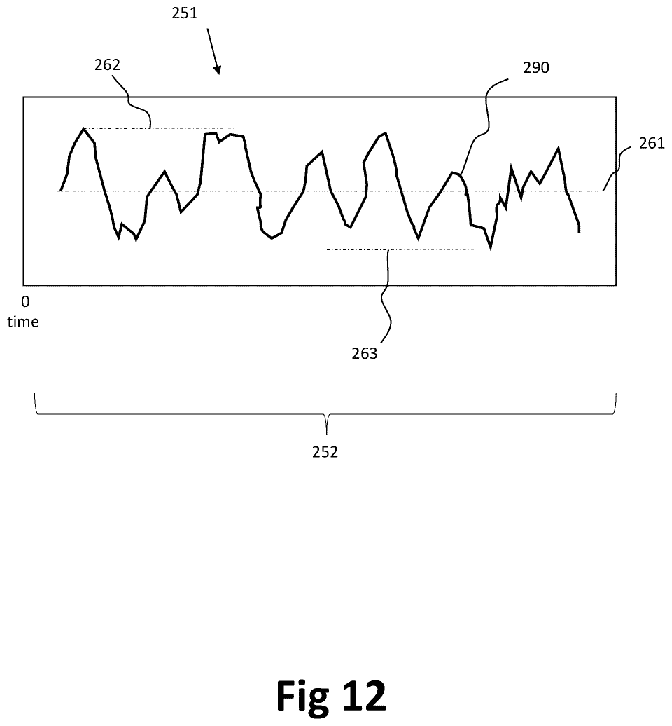

Sliding time windows are a well-known method utilized in human activity recognition and other time series machine learning models. An example time window 251 is shown in FIG. 12. Time window 251 has a predetermined width 252 which may be time or a number of data points of a data stream 290. According to the present disclosure, a time window of between 1 second and 5 seconds can provide acceptable results. Smaller window widths typically perform better on faster motions and with tasks and states changing quickly. Data from pre-process step 240 is moved into bunches of time sequenced data to form numerous of time window 251. A features step 260 is performed on the data stream 290 of time window 251 to create machine learning features. As shown in FIG. 12 and according to the present disclosure, a maximum 262, an average 261 and a minimum 263 is computed as machine learning features. Other statistical features may be generated, including but not limited to, standard deviation, difference of maximum and minimum values, median, and number of peaks.

After feature step 260, a classify step 270 is performed. Well understood in the art of machine learning, classify step 270 takes the features generated from features step 260 for time window 251 and outputs a classification, in the case of the present disclosure the classification is the type of state 61. Classify step 270 may also output a probability or confidence with an associated classification. A save step 280 stores the state outputted by classify step 270 within server system 50. When instructed, server system 50 creates output 100.

As shown in FIG. 11, a data capture session may result in the classification of multiple states. In addition to state 61, system 10 may classify state 61A and follow a similar process as for state 61. For more complex states, such as determining fatigue, stress, or strain, the output of one state may be an input to another state classification. Such as example is shown in the process for a state 61B of FIG. 11. The saved output for state 61A may be an input for a window step 250C or as a feature as part of a features step 260C. Although FIG. 11 shows three different states to be classified for task 222, it should be appreciated that the present disclosure is not to be construed to be limited to any number of tasks, states, or classification steps to generate output 100. It should also be appreciated that for any given state, a unique and optimized value for window width 252 may be utilized.

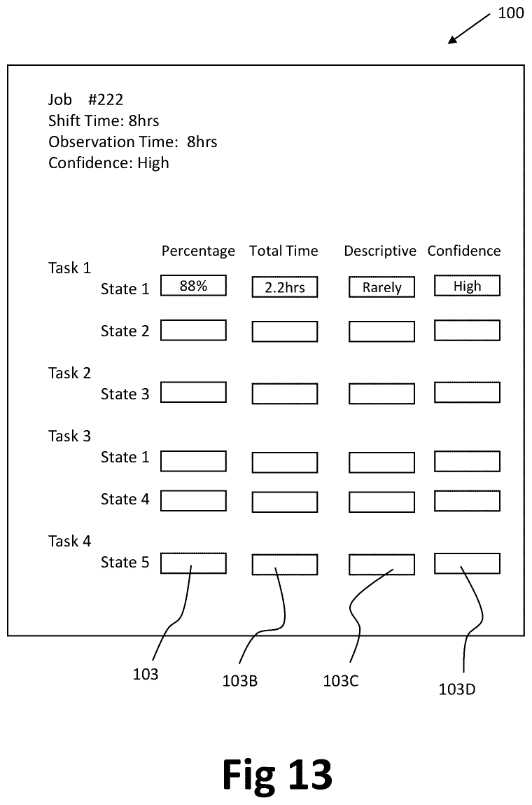

An example of output 100 is shown in FIG. 13. A given job is listed and may include data from server system 50 such as total data capture time, or a percentage of an actual shift time when data was captured with system 10. A given job is broken down into its tasks and states associated with those tasks. Ultimately, system 10 outputs a state duration value 103 for a given task or for a given job. In the example shown in FIG. 13, state duration percentage 103 is shown as a percentage of job time someone performing the job would be in that state. Alternatively, a state duration total 103B, may be the total time during a shift that someone performing the job would be in that state. Alternatively, a state duration description 103C may be a text value providing a range for how often someone performing the job would be in that state. Server 50 processes multiples of window 251, sensor timestamp 38A, session timestamp 48C, and session data 48A to create states for computing the total session time and outputs 103, 103B, 103C. Leveraging machine learning, a state confidence value 103D may be provided for providing the level of confidence in the results shown for state 103, 103B, or 103C. A low confidence value 103D may indicate an end user of system 10 to do more data collection or training for a given task or state. Process 200 provides the means to capture data that enables multiple complex states of a job and its tasks to be computed in real-time and in parallel.

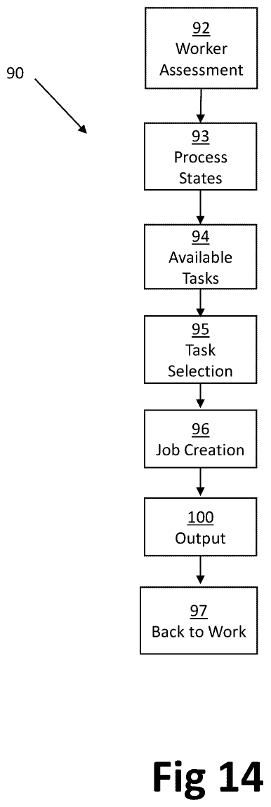

While understanding the requirements of a job is of significant value, the present disclosure can also be used to match workers to jobs, or to create an optimized job for a particular worker. An optimized job creation process 90 is shown in FIG. 14. Although process 90 is described herein as a method to create an optimized job for an injured worker, the present disclosure and its methods should not be limited to such. A first worker assessment step 92 is performed on an injured worker. Assessment step 92 is typically done a physician wherein they evaluate the worker, assess risk, and describe what an injured worker can and cannot do. For example, a doctor may document a worker should not do anything that requires them to stand for more than 2 hours. A doctor may document a worker should not carry anything over 20 pounds. A doctor may document a worker should not raise their arms overhead. These limitations are generally aligned, but not always aligned, with the states 61-64 of the present disclosure. It should be appreciated that while states 61-64 are used as an example in the present disclosure, doctor described states and the present disclosure should not be limited to any number or type of states.

After worker assessment step 92, the doctor documented states are then fed into system 10 as input through a process states step 93 which utilizes states and their allowable state duration. As an available tasks step 94, system 10 then looks at saved states from process 200 and identifies and presents to the user of system 10 tasks that do not exceed state durations of states from process states step 93. As a task selection step 95, system 10 then either identifies high value tasks and automatically selects them or enables the user of system 10 to choose individual tasks from available tasks step 94. The chosen tasks are then used by system 10 in a job creation step 96 which sums up all the tasks and state requirements of an optimized job and ensures it does not exceed the limitations for the worker described by worker assessment step 92. System 10 then creates output 100 which describes the optimized job, its tasks, and state requirements. Output 100 will thus match the capabilities and limitations of the worker as described by worker assessment step 92. Output 100 will describe a job that potentially maximizes value for the company while also ensuring the safety and health of the worker. Through a back to work step 97, the worker performs the optimized job described by output 100.

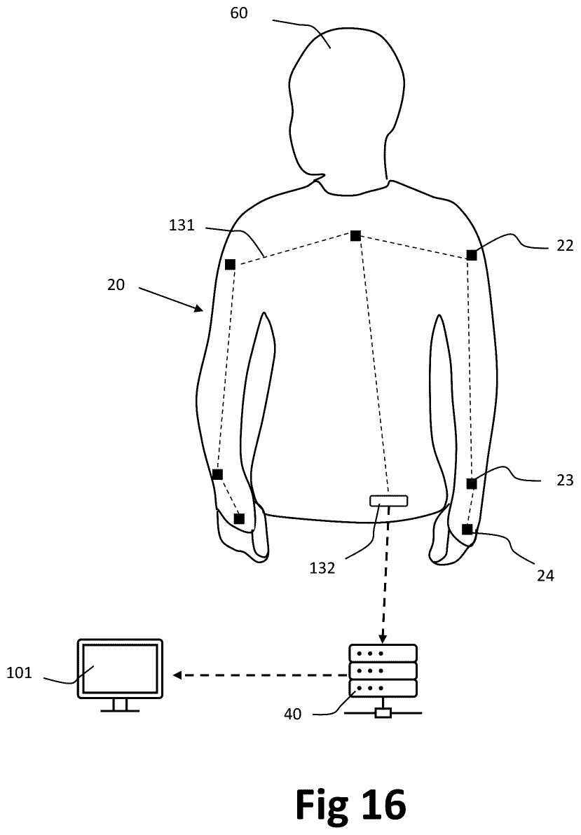

Other embodiments of the present disclosure are possible within its spirit and scope. One such embodiment is shown in FIG. 16. In this wired harness embodiment, sensors 21-29 do not communicate wirelessly to gateway 40, but rather communicate to an on-body gateway 132 over a wired harness 131 attached or embedded in garment 70. Communication between on-body gateway 132 and sensors 21-29 can be done utilizing any standard electronics protocol, including but not limited to RS-485 an I2C. A flexible harness is described by co-owned U.S. application number PCT/US2023/012216 or U.S. application Ser. No. 63/442,886 which is herein incorporated by this reference. Wired harness 131, while more technologically complex than the best mode described above, provides the ability to standardize sensor locations, reduce session setup time, and simplify data requirements.

Another embodiment may include the functions of server 50 and its processor 51 to be included in gateway 40 and gateway processor 41, or vice versa. Such an embodiment would allow a single computing device to both act as a gateway and server for outputting data. Such a device could be useful where a cloud service is not desired, or a gateway is only needed for a small subset of workers. The present disclosure may combine server second processor 51 and gateway first processor 41.

In yet another embodiment, rather than using a traditional supervised machine learning model that utilizes pre-determined features, such as K-nearest neighbors or decision trees, a neural network embodiment may be utilized. With significant amounts of data, neural networks may outperform traditional models. In this embodiment, the present disclosure may not utilize statistical features but rather leverage neural network features such as hidden layers. In the case of convoluted neural networks, features 261-263 may be replaced or created by pooling layers, filtering layers, and weights. It should be appreciated that the spirt and scope of the present disclosure is not dependent upon an exact machine learning classifier type.

While the wearable driven job assessment system herein described constitute preferred embodiments of the present disclosure, it is to be understand the present disclosure is not limited to these precise components, assemblies or methods, and that changes may be made therein without departing from the scope and spirt of the disclosure.

We claim:

1. A system comprising:
(A) one or more sensor modules;
(B) a garment, wherein the one or more sensor modules are configured to generate movement data related to the movement of the garment and timestamp data;
(C) a first processor, wherein the first processor is configured to:
i) communicate with the one or more sensor modules;
ii) receive the movement data and timestamp data;
iii) store in a memory module a session data; and
iv) create one or more session messages comprising the session data from each of the one or more sensor modules;
(D) a second processor, wherein the second processor is configured to:
i. receive the one or more session messages from the first processor;
ii. compile the one or more session messages in order of the timestamp data;
iii. create a plurality of time windows comprised of a pre-determined and sequential amount of session messages;
iv. compute a feature of at least one of the plurality of time windows, wherein the feature comprises at least a minimum value, a maximum value or a standard deviation;
v. utilize at least two of a pre-trained job task classifier for determining at least two states for at least one of the time windows;
vi. determine a total session time;
vii. aggregate each of the time windows by each of the at least two states and compute for each of the at least two states a total state output value wherein the state output value is a function of said total session time; and,
viii. output a job task summary comprised of at least two of the total state output values.

2. The system of claim 1 wherein each of the sensor modules is configured to determine at least one of acceleration data, gyroscopic data, tilt data, location (GPS) data, environmental data, heart rate data, body temperature data, blood pressure data, quaternion, stretch, flex, or a combination thereof.

3. The system of claim 1, wherein the session data comprises a body location for each of the one or more sensors on the garment.

4. The system of claim 1, wherein the second processor is further configured to filter session messages.

5. The system of claim 1, wherein the job task summary quantifies the kinematic requirements of a job performed by a subject of the system.

6. The system of claim 1, wherein the system comprises two or more garments, each garment comprising one or more sensor modules, and the first processor is configured to store a session identifier that is different for each of two or more subjects.

7. The system of claim 6, wherein the second processor is configured to compile the one or more session messages in order of the timestamp data and by the session identifier.

8. The system of claim 1, wherein the first and second processors are the same.

9. The system of claim 1, wherein the first or second processor calculates a joint angle of a subject.

10. The system of claim 1, wherein job task summary further comprises a classification of at least one of stress and fatigue.

11. A system comprising:
A) one or more sensor modules;
B) a garment, wherein the one or more sensor modules are configured to generate movement data related to the movement of the garment and timestamp data;
C) a first processor, wherein the first processor is configured to:
i) communicate with the one or more sensor modules;
ii) receive the movement data and timestamp data;
iii) store in a memory module a session data; and
iv) create one or more session messages comprising the session data from each of the one or more sensor modules;
D) a second processor, the second processor configured to:
i) receive the one or more session messages from the first processor;
ii) compile the one or more session messages in order of the timestamp data;
iii) create a plurality of time windows comprised of a pre-determined and sequential amount of session messages;
iv) compute a feature of at least one of the plurality of time windows, wherein the feature comprises at least a minimum value, a maximum value or a standard deviation;
v) utilize a first pre-trained state classifier for determining a first state for at least one of the time windows;
vi) utilize a second pre-trained state classifier for determining a second state for at least one of the time windows;
vii) determine a total session time;
viii) aggregate each of the time windows by each of the at least two states and compute for each of the at least two states a total state output value wherein the state output value is a function of said total session time; and
ix) output a job task summary comprised of at least two of the total state output values.

12. The system of claim 11 wherein each of the sensor modules is configured to determine at least one of acceleration data, gyroscopic data, tilt data, location (GPS) data, environmental data, heart rate data, body temperature data, blood pressure data, quaternion, stretch, flex, or a combination thereof.

13. The system of claim 11, wherein the session data comprises a body location for each of the one or more sensors on the garment.

14. The system of claim 11, wherein the second processor is further configured to filter session messages.

15. The system of claim 11, wherein the job task summary quantifies the kinematic requirements of a job.

16. The system of claim 11, wherein the system comprises two or more garments, each garment comprising one or more sensor modules, and the first processor is configured to store a session identifier that is different for each of two or more subjects.

17. The system of claim 16, wherein the second processor is configured to compile the one or more session messages in order of the timestamp data and by the session identifier.

18. The system of claim 11, wherein the first and second processors are the same.

19. The system of claim 11, wherein the first or second processor calculates a joint angle of a subject.

20. The system of claim 11, wherein job task summary further comprises a classification of stress or fatigue.
